(19) United States
(12) Patent Application Publication
(10) Pub. No.: US 2009/0265449 A1
(43) Pub. Date: Oct. 22, 2009

(54) Method of Computer Clustering

(75) Inventors: Nagendra Krishnappa, Bangalore (IN); Sudhindra Prasad, Arnes, IA (US)

Correspondence Address: HEWLETT-PACKARD COMPANY;Intellectual Property Administration, 3404 E. Harmony Road, Mail Stop 35, FORT COLLINS, CO, 80528, US

(73) Assignee: HEWLETT-PACKARD DEVELOPMENT COMPANY, L.P., Houston, TX (US)

(21) Appl. No.: 12/427,615

(22) Filed: Apr. 21, 2009

(30) Foreign Application Priority Data
Apr. 22, 2008 (IN) 995/CHE/2008

(51) Int. Cl. G06F 15/177; G06F 15/173

(52) U.S. Cl. 709/220; 709/224

(57) ABSTRACT

A method for clustering comprising acquiring the required number of nodes for cluster formation based on node selection criteria; electing a cluster coordinator; and assigning the packages on the member nodes. The cluster coordinator is elected based on the mean time between failures value of the member nodes which may be calculated with the help of a diagnostic tool by logging the failure instances of the member nodes.

### RELATED APPLICATIONS

Pursuant to 35 U.S.C. 119(b) and C.F.R. 1.55(a), the present application corresponds to and claims the priority of Indian Patent Application No. 995/CHE/2008, filed on Apr. 22, 2008, the disclosure of which is incorporated herein by reference in its entirety.

### BACKGROUND

A computer cluster is a collection of one or more complete computer systems, having associated processes, that work together to provide a single, unified computing capability. The perspective from the end user, such as a business, is that the cluster operates as through it were a single system. Work can be distributed across multiple systems within the cluster. Any single outage, whether planned or unplanned, in the cluster will not normally disrupt the services provided to the end user. That is, end user services can be relocated from system to system within the cluster in a relatively transparent fashion. Clustering technology that exists today takes mostly a multilateral view of the cluster nodes. Whenever a new node joins a cluster or a cluster member node halts or fails, a cluster reformation process is initiated. The cluster reformation process may broadly be divided into two phases, a cluster coordinator election phase and an establishing cluster membership phase. The cluster coordinator election phase is executed only if the coordinator does not already exist. This would happen when a cluster becomes active for the first time or when the coordinator itself fails. The second phase is an integral part of the cluster reformation process, and is executed each time the reformation happens.

When a cluster becomes active for the first time, a cluster coordinator is selected among the member nodes. The cluster coordinator is responsible for forming a cluster, and once a cluster is formed, for monitoring the health of the cluster by exchanging heartbeat messages with the other member nodes. The cluster coordinator may also push out failed/halted nodes out of the cluster membership and admit new nodes into the cluster. The task of selecting the cluster coordinator may be termed as the cluster coordinator election process. The cluster coordinator election process takes place not only when the cluster becomes active; but may also happen when the cluster coordinator node fails for any reason in a running cluster.

### BRIEF DESCRIPTION OF THE DRAWINGS

Embodiments of the invention will now be described, by way of example, with reference to the accompanying drawings, in which:

FIG. 1 is a diagram showing an example of an environment in which the present invention may be implemented.

FIG. 2 is a diagram showing an example of a previously known algorithm for cluster coordinator election process.

FIG. 3 is a diagram showing the steps of an algorithm for dynamic cluster formation.

FIG. 4 is diagram showing steps of an algorithm for updating MTBF values of member nodes in a cluster system.

FIG. 5a is a flow chart illustrating the steps involved in an algorithm for election of cluster coordinator.

FIG. 5b is a flow chart illustrating the steps involved in an algorithm for election of cluster coordinator based on the node ID table.

FIG. 6 is a flow chart illustrating the steps involved in an algorithm for assigning packages to the member nodes.

### DETAILED DESCRIPTION

A method of clustering by acquiring required number of nodes for cluster formation, electing a cluster coordinator and assigning packages to the member nodes is disclosed. In the following description, for purposes of explanation, numerous specific details are set forth in order to provide a thorough understanding of the various embodiments. It will be evident, however, to one skilled in the art that the various embodiments may be practiced without these specific details.

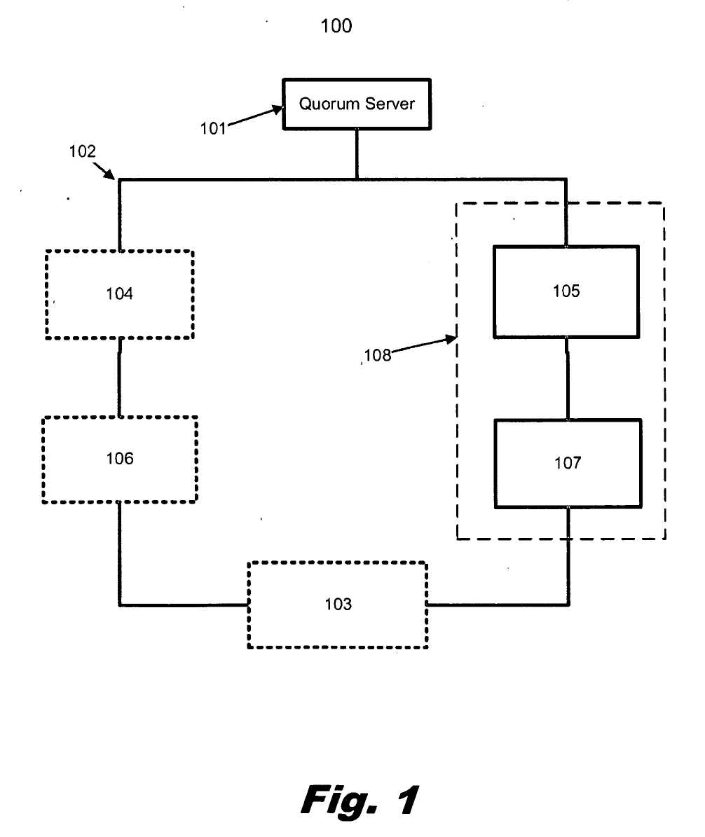

FIG. 1 illustrates exemplary computing environment 100 comprising a quorum server 101 and five computing nodes 103, 104, 105, 106, 108 connected through a communication system 102. Computing nodes 105 & 107 are member of a cluster system 108. Computing nodes 103, 104 and 106 are not member of any cluster system. The nodes which are not member of a cluster system may also be called as free nodes. The computing nodes and/or the member nodes of a cluster may be a server computer or a computing device. A member node may also be a computing process, so that multiple nodes may exist on the same server, computer or other computing device. A cluster and its elements, may communicate with other nodes in the network through a network communication 102. For example, the network communication 102 is a wired or wireless, and may also be a part of LAN, WAN, or MAN. The communication between member nodes of a cluster may take place through communication interfaces of the respective nodes coupled to network communications 102. The communication between member nodes of a cluster may be through a particular protocol, for example TCP/IP.

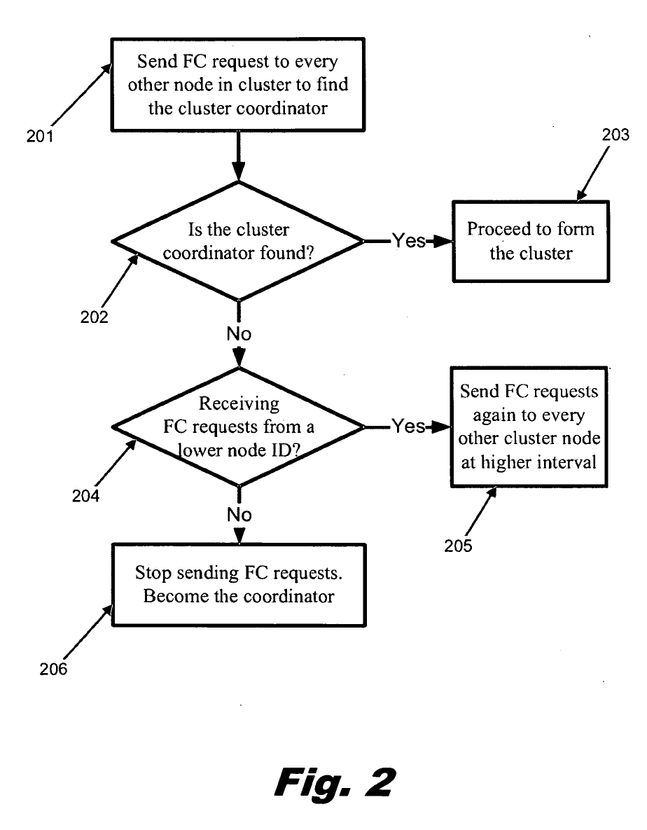

A conventional method for cluster coordination election, depicted in FIG. 2, is to use a rigid selection process based on pre-determined node IDs. Each node in a network is assigned a pre-determined ranking or a node ID. When a cluster fails and process of formation of a new cluster begins, at step 201, each node starts with sending Find Coordinator (FC) requests to every other member node in the cluster at regular time intervals. If the member nodes find a cluster coordinator, they may at step 203 proceed to form a cluster. If no cluster coordinator is found the nodes may check if they are receiving FC request from the lower node ID. If a node is receiving a FC request from a lower node ID, the node at step 205 may send FC requests again to every other cluster node at higher interval. If at step 204, a node is not receiving any FC requests from the lower node ID then it may at step 206 stop sending FC requests to the member nodes and becomes the cluster coordinator. The newly self declared cluster coordinator may start the process of cluster formation. So a node which has the lowest node ID will eventually become the cluster coordinator.

Similarly, package failover decisions in a cluster are either statistically determined or are based on presumed information or heuristics. The presumed information may include the hardware information, package queue of the member nodes for instance. Failover is the capability to switch over automatically to a redundant or standby computer server, system, or network upon the failure or abnormal termination of the previously active server, system, or network. Failover happens without human intervention and generally without warning, unlike switchover. The node to which a package can failover, upon node/package failure, is either pre-configured by the user or determined on the basis of potentially misleading data like package count. In this context, the term package is used to refer to an application along with resources used by it. Resources such as the virtual internet protocol address, volume groups, disks, etc., used by the application together constitute a package.

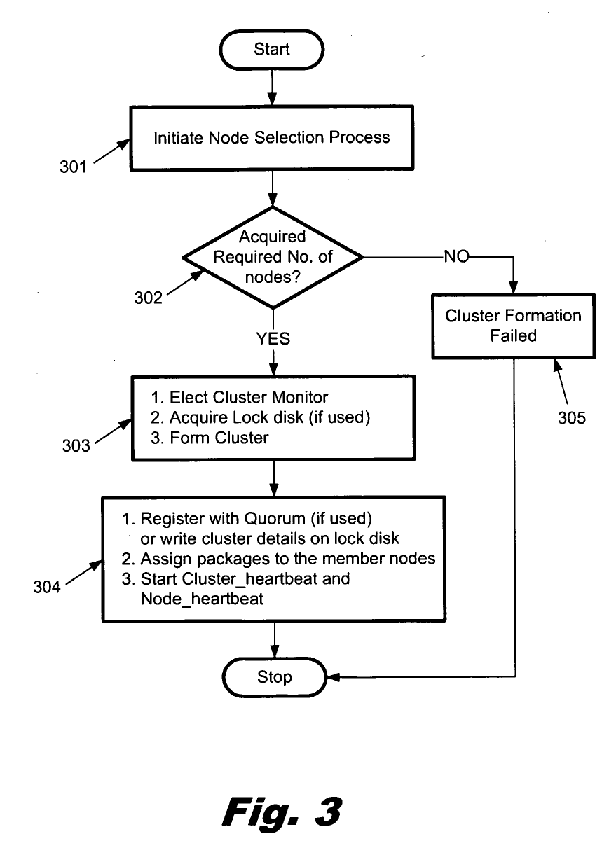

FIG. 3 illustrates the steps involved in an algorithm 300 for formation of a cluster system. The cluster formation process may be initiated by the cluster administrator through any node in the network by stating the requirement to be a cluster with ‘n’ number of member nodes through an Input Configuration file. The cluster formation may also be triggered by a remote cluster manager when a priority cluster is down as it fails to receive cluster heartbeat messages from the failed cluster. The cluster formation may be triggered at a free node i.e. a node which is not a part of any running cluster in the network. After the initialization of cluster formation the free node may initiate the node selection process at step 301.

Continuing to step 302 of FIG. 3, the free node may check if the required number of nodes for the cluster formation has been acquired. The required number of nodes may be acquired based on a criteria specified by the cluster administrator and/or specified in the cluster configuration file. The selection criteria may comprise hardware probe, user list, capacity adviser, random, for instance. As an example the user may set a minimum hardware configuration that a cluster member should possess to qualify as member node for a given cluster system. A demon may be started on each node in the network during node startup to collect the underlying hardware information. During cluster creation and/or re-configuration the demons will exchange the hardware information on request with the node where cluster creation was initiated and decide upon the list of nodes that will form a cluster. As another example the user may give a prioritized list of potential nodes that the may be used during cluster formation. As yet another example use the nodes suggested by a capacity advisor such as Work Load Manager and/or may pick any random node in the network.

After acquiring the required number of nodes at step 302, the free node may proceed to step 303 to form the cluster. The cluster formation process may include copying of the cluster configuration files on the member nodes. If the free node is not able to acquire the required number of nodes, at step 205 may stop the cluster formation process and send a cluster formation failure message to the cluster administrator.

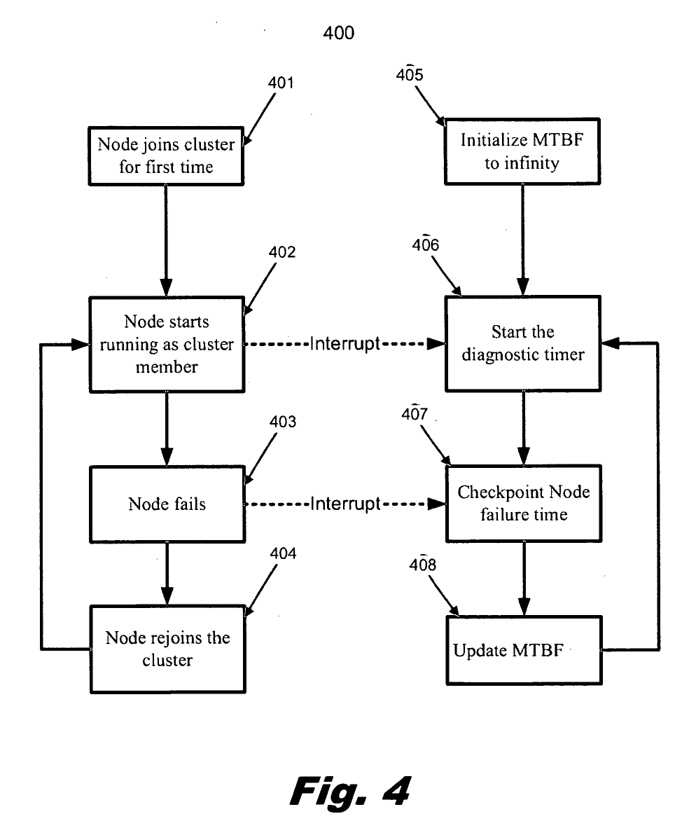

Further continuing to step 303, after acquiring the required number of nodes, the cluster formation process is initiated. At step 303 the cluster members may elect a member node as the cluster coordinator. An algorithm 400 for electing a cluster coordinator is described with respect to FIG. 4. The cluster coordinator may also acquire a lock disk if used to avoid formation of redundant cluster in a network.

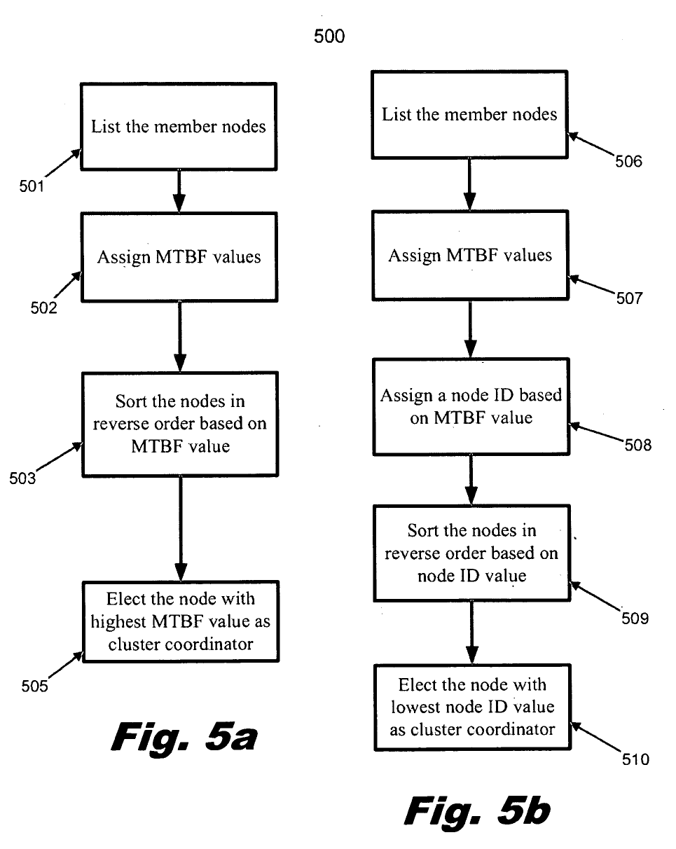

After completion of cluster formation process, the cluster coordinator may at step 304 register with the quorum server 101 with cluster information and package details running on the cluster if any. The quorum server 101 serves as a central database where the latest information about the status of a cluster may be obtained. All running clusters in the network are required to update their cluster information and package details running on the cluster with the quorum server 101. After registration of the new cluster with the quorum server 101, the cluster coordinator may start sending a cluster heartbeat message to other cluster coordinators present in the network as well as to the member nodes. The newly elected cluster coordinator may also assign packages to the cluster members for execution. An algorithm 500 for assigning packages to the member nodes is described with respect to FIG. 5.

FIG. 5a and FIG. 5b illustrates an algorithm 500 for election of the cluster coordinator. The cluster coordinator election is based on the mean time between failures (MTBF) values of member nodes. A member node with the highest MTBF value in the cluster system may be elected as the cluster coordinator. The algorithm may be executed on a selected member node of the cluster system.

The MTBF value may be defined as the average time elapsed between two consecutive failures of a member node. For calculating the MTBF value, only the cluster membership age of a node may be considered. Hence the time spent by the node outside the cluster may not be factored in while calculating the MTBF value.

The MTBF value of a member node may be calculated using the node failure time logged by a diagnostic tool running on the cluster. The MTBF value of a member node may also be calculated with the help of cluster-ware which may be implemented using a kernel thread to perform the required diagnosis. The above mentioned diagnostic tool and/or kernel thread should be able to measure time spent by a member node within a cluster and tool and/or thread will checkpoint every time there is a cluster reformation, and help to determine the MTBF value of a node. The diagnostic tool may also be provided on each member of the cluster node.

An algorithm 400 for calculating MTBF value of a member node of a cluster system is described with reference to FIG. 4. The MTBF value of a node is activated at the instant when the node joins the cluster as a member node for the first time 401. At step 405 the member node may be assigned an initial MTBF value. The initially assigned MTBF value may be a random value and/or predetermined value set by the user. As an example the initial value of a member node may be assigned as infinity. Since the algorithm 400 is a self-learning method and collects data over a period of time to prioritize the member nodes for getting elected as coordinator. The MTBF value of a member node which has not even failed once may approach infinity. Further when a node starts running as a cluster member at step 402, the diagnostic tools are evoked on the node to checkpoint the failure instances of the member nodes 406.

At step 403 of FIG. 4, a member node in the cluster system may fail at a given time instant. At step 407, the diagnostic tool running on the cluster system may checkpoint the node failure time for the failed member node by sending an interrupt message. The node failure time may be used to calculate the new MTBF value of the failed member node using mathematical equation (1). At step 404, the failed member node may after rectification rejoin the cluster system. The timer of the diagnostic tool is restarted for the member node rejoining the cluster after a failure. After rejoining, the member node may update its MTBF value table from the running members of the cluster.

In some embodiments the member nodes of a cluster may be assigned a node ID based on their MTBF value. The node ID is the rank of a member node in the cluster system based on the MTBF values of all of the member nodes. A member node with the highest MTBF value may be assigned the lowest node ID. The node with the second best MTBF value is assigned a second lowest node ID and so on. A table of member nodes may be created with increasing value of node ID i.e. the member node with lowest node ID as first element and the member node with the highest node ID as the last. The node ID table may be stored at the quorum server 101 and/or the cluster disk. The node ID table may be updated to reflect the latest value of MTBF values of member nodes. The node ID table may be updated on a regular time interval predetermined by the user and or in event of a change of MTBF value of a member node. The node ID table is also made available to each member nodes of the cluster. In case of any change in the node ID table, the cluster coordinator may broadcast the most updated table for the member nodes to update their own table. This table may be requested from the cluster coordinator by a member node.

The MTBF value of a node may mathematically be represented as

$$M T B F = \frac{{\sum }_{n = 2}^{m} Tn - Tn - 1}{m} \qquad ( 1 )$$

Wherein:
Tₙ=Time at which the n^{th} failure happened
Tₙ₋₁=Time at which the (n−1)^{th} failure happened
Tₙ₋₁=Node failure count
m=Total Number of failures at the node failure instant Tₘ

The MTBF value of a member node that has not failed yet is closer to infinity which is may be derived from equation (1). As an example, the MTBF value of a member node after the first failure may be calculated as T₁—(Cluster formation Time) where T1 is the time at which first failure happened.

The MTBF value table may be consistent across the member nodes. Whenever a new node joins the cluster or a failed member node rejoins the cluster, the node may update its MTBF value table from a running node and/or the central database. The MTBF value table on each member node may have a cluster-wide timestamp. A cluster wide timestamp may ensure that when whole cluster fails together, and is reformed, the most updated table of the MTBF value is available. Thus, the historical data on node behavior is not lost and is updated.

The pseudo-code for the algorithm 400 to update MTBF value and/or node ID of a node may be represented as:

```
    If (cluster active for first time)
    {
    For I in 1,2,3..n
    do
        Node[I].MTBF = <high value>
        Node[I].NodeID = I; // assigning random values
    done
    continue;
    }
    For I in 1,2,3...n
    do
    Node[I].MTBF = getMTBFFromDiagnosticInfo(Node[I]);
    done
    // Sort the nodeID values of nodes in the reverse order of their MTBF
values
    For I in 1,2,3...n−1
    do
    For J in 2,3....n
    do
        If (Node[I].MTBF < Node[J].MTBF)
        Swap(Node[I].nodeID, Node[J].nodeID);
    done
    done
```

During the cluster formation process, if a cluster coordinator does not exist, the algorithm 400 may execute in each member node of the cluster system. In the first few cluster formation and/or reformation processes, there may be more than one contender for the cluster coordinator as the MTBF values of two or more nodes may be same. In case of more than one member node with same MTBF value, one of these member nodes may be selected randomly as the cluster coordinator. With cluster age progression, as nodes keep failing and coming up, the MBTF value of nodes mostly differ from one another resulting in a more accurate node ID distribution.

According to an embodiment, the MTBF values of each member node of a cluster system may be checkpointed onto a file along with other cluster details that need to be preserved across node reboots. Once a node reboots, the MTBF value may be corrected and/or updated to reflect current MTBF values by exchanging information with other member nodes. When a new node joins a cluster, the node may exchange MTBF data from other active member nodes.

Continuing to step 501 of FIG. 5a, the selected member node may list all member nodes of the cluster. This list may comprise only member nodes which were active at the time of creation of the list. This list of member nodes may also be obtained from the cluster coordinator if available or the cluster configuration file. The free node then at step 502 may assign a MTBF value to each of the member nodes. The assigned MTBF values are the most updated values available at the central location. At step 503, the member nodes are sorted in reverse order of their respective MTBF values. A member node with the highest MTBF value may be elected as the cluster coordinator. The MTBF value of a member node may indicate the probability of the node failure. According to an embodiment the lower the MTBF value of a member node, the greater are the chances of it failing again. A higher value of MTBF means the member node is reasonably stable and may be expected to remain so. Most of the latency during cluster reformation is introduced by the election of the cluster coordinator. Avoiding the process of cluster coordinator election may improve the cluster reformation time significantly. One way to avoid the cluster coordination election process, would be to ensure that an existing coordinator remains alive during cluster reformation. In other words, the cluster coordinator should be made as stable as possible so that it will not be a trigger for cluster reformations.

FIG. 5b illustrates an algorithm for cluster coordinator election based on the node ID table. The algorithm may execute on the cluster coordinator node if available or any node in the cluster system including the free node. At step 506 of FIG. 5b, the free node may list all member nodes of the cluster. This list may comprise only member nodes which were active at the time of creation of the list. This list of member nodes may also be obtained from the cluster coordinator or the cluster configuration file. The free node then at step 507 may assign a MTBF value to each of the member nodes. The assigned MTBF values are the most updated values available at the central location. At step 508, the member nodes are assigned a node ID based on the MTBF value. Continuing to step 509 the nodes are sorted in reverse order of the node ID values. Further continuing to step 510, a member node with the highest node ID value may be elected as the cluster coordinator.

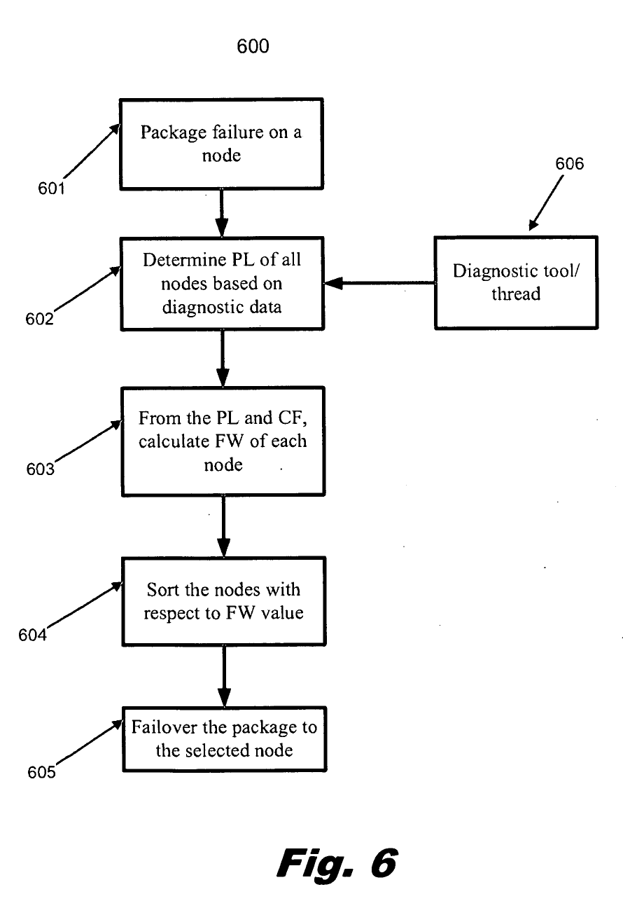

FIG. 6 illustrates an algorithm 600 to assign and/or re-assign packages in a cluster system. The algorithm 600 may be used to assign packages to the member nodes in newly formed cluster system. The algorithm 600 may also be used to re-assign the packages of a failed node to other active nodes in a running cluster system. One of the factors to influence package failover may be MTBF value of the member node. The package failover decisions based entirely on the MTBF value of the nodes may expose the cluster to a single point of failure as all the packages may potentially failover to the same member node in the cluster.

To facilitate the package distribution across the member nodes more evenly, the algorithm may consider additional determinants for example Critical Factor (CF) of package and Package Load (PL) of a member node to calculate a failover weight (FW) for a package.

The critical factor of a package may indicate required degree of package availability or the priority of the package relative to other packages in the cluster. The CF value of a package may indicate the importance of the application and the downtime tolerance of the application. The CF value for a package may be preconfigured by the cluster administrator and/or the user.

Package Load of a member node may indicate the amount of current package load on the member node. The package load may be represented as a function of central processing unit (CPU) and I/O overhead introduced by the packages executing on the member node. The PL of a member node may be calculated based on diagnostic information like system CPU utilization, I/O rate for example.

As an example, the higher the CF of a package, the lower should be the node ID of its failover target to make node as adoptive node. Also, the higher the PL of a member node, the lesser should be its priority for being the failover target of a package.

The FW value of a member node for a package may mathematically be represented as:

For a package “P” and a member node “N”.

PL(N) is the total package load measured on member node N.

CF(P) is the critical factor assigned to the package P.

Considering this, the Failover Weight (FW) of the member node may be calculated as

FW(N,P)=CF(P)/[NodeID(N)×PL(N)] (2)

Failover Weight (FW) of a member node N for a package P may be defined as the priority of the member node for the package P to failover to the member node N. The higher the FW of a member node for a package, the higher is its priority to be the failover target of that package. The FW of a member node N is calculated for each package P running on the cluster.

At step 601, a package may fail in a cluster system. A package may fail due to failure of the member node on which the package was being processed. A package may also fail due to inability of assigned member node to execute the applications. At step 602 the cluster coordinator may collect the PL and CF of all the member nodes in the cluster system. The PL and CF may be collected using a diagnostic tool running on the cluster system or with the help of a separate thread in the kernel module and/or application module. The cluster coordinator may also get the most updated table of the MTBF value of the member nodes. This value may be obtained from the cluster central disk, cluster coordinator and or an active member of the cluster.

Continuing to step 603, the cluster coordinator by using the algorithm 600 may calculate the FW value for each of the member node in the cluster system. The FW value for the member nodes may be calculated using PL, CF and MTBF value in mathematical equation (2). At step 604, the nodes of the cluster system are sorted based on the FW values for each package running on the cluster.

Further continuing to step 605, the failover package may be assigned to the member node with the highest FW value in the cluster for that package. A priority list of the member nodes may be prepared based on the FW values for all the packages in the cluster. The FW value for each of the packages running on the cluster for each of the member nodes is stored with the cluster coordinator and/or the central disk along with cluster configuration files. The priority list may be used to assign the packages to a new node in case of a node failure.

Various embodiments may further include receiving, sending or storing instructions and/or data implemented in accordance with the foregoing description upon a carrier medium. Generally speaking, a carrier medium may include computer readable storage media or memory media such as magnetic or optical media, e.g., disk or CD-ROM, volatile or non-volatile media such as RAM (e.g. SDRAM, DDR SDRAM, RDRAM, SRAM, etc.), ROM, etc. as well as transmission media or signals such as electrical, electromagnetic, or digital signals, conveyed via a communication medium such as network and/or a wireless link.

In reading the above description, the persons skilled in the art will realize that there are many apparent variations that can be applied to the methods described. A first variation is a setup where a failed package is being restarted in a cluster. In the forgoing specification, the invention has been described with reference to specific exemplary embodiments thereof. It will, however, be evident that various modifications and changes may be made to specific exemplary embodiments without departing from the broader spirit and scope of the invention set forth in the amended claims. Accordingly, the specification and drawings are to be regarded in an illustrative rather than a restrictive sense.

What is claimed is:

1. A method of forming a computer cluster comprising:
receiving, at a node, a request to create a dynamic cluster;
acquiring the required number of member nodes for cluster formation based on a node selection criteria;
electing a cluster coordinator from the member nodes;
wherein the cluster coordinator is elected based on a mean time between failures value of the member nodes.

2. A method of claim 1 wherein the time spent by a node within the cluster is measured with a cluster ware with a thread implemented to perform required diagnosis.

3. A method of claim 1 wherein the mean time between failures value of member nodes is assigned randomly on the initialization of the cluster.

4. A method of claim 1 further comprising assigning a node ID to the member nodes based on the mean time between failures.

5. A method of claim 1 wherein the node with the highest meantime between failures value is elected as cluster coordinator.

6. A method as claimed in claim 4 wherein the node with the lowest node ID is elected as cluster coordinator.

7. A method of claim 1 further comprising in case of more than one member node with same mean time between failures value and/or node ID a cluster coordinator is elected randomly.

8. A method of forming a computer cluster comprising:
receiving, at a node, a request to create a dynamic cluster;
acquiring the required number of member nodes for cluster formation based on a node selection criteria;
electing a cluster coordinator from the member nodes;
assigning packages to the member nodes
wherein the packages are assigned based on a failover weight of the member nodes for a package, the failover weight being based at least partly on a mean time between failures value of a node.

9. A method of claim 8 wherein the failover weight of node for a package is calculated as critical factor of the package over mean time between failures value of a node and package load of the node.

10. A method of claim 9 wherein critical factor of a package is the required degree of package availability.

11. A method of claim 9 wherein the critical factor of a package is the priority of the package relative to other packages in a computer cluster.

12. A method of claim 9 wherein the package load of a node is a function of CPU and I/O overhead introduced by the packages on a node.

13. A method of claim 9 wherein a package is assigned to a node with the highest failover weight for the package.

14. A computer program product for clustering, the computer program product comprising storage medium readable by a processing circuit and storing instruction for execution by a processing circuit for performing a method comprising the step of comprising:
receiving, by a node, a request to create a dynamic cluster;
acquiring the required number of member nodes for cluster formation based on a node selection criteria; and
electing a cluster coordinator and assigning the packages on the member nodes;
wherein the cluster coordinator is elected based on the mean time between failures value of the member nodes and/or the packages are assigned based on the failover weight of the node for a package.

15. A computer program product of claim 14 wherein failover weight of a package for a node is calculated as critical factor of the package over mean time between failures value of a node and package load of the node.
